(19) United States
(12) Patent Application Publication
(10) Pub. No.: US 2013/0225196 A1
(43) Pub. Date: Aug. 29, 2013

(54) Geo-Fence Generation and Updating Based on Device Movement Patterns

(71) Applicants: Bryan J. James, Menlo Park, CA (US); Michael I. Ingrassia, JR., San Jose, CA (US)

(72) Inventors: Bryan J. James, Menlo Park, CA (US); Michael I. Ingrassia, JR., San Jose, CA (US)

(21) Appl. No.: 13/406,406

(22) Filed: Feb. 27, 2012

(51) Int. Cl. H04W 4/02

(52) U.S. Cl. 455/456.1

(57) ABSTRACT

The disclosed implementations provide a system and method of generating or updating a geo-fence surrounding a geographic region based on movement patterns of a device operating within the geographic region. In some implementations, an anchor location is selected by a user or application. A default geo-fence can be generated to surround a region containing the anchor point. Data points are collected by the device based on sensor data and time stamps collected over a selectable period of time. The system analyzes the data points to generate a geo-fence surrounding a geographic region containing the anchor location (if no default geo-fence is defined) or updates the default geo-fence to encompass more or less of the geographic region.

### TECHNICAL FIELD

This disclosure is related generally to electronic notification systems.

### BACKGROUND

A geo-fence is a virtual perimeter for a real-world geographic area that can be dynamically generated by defining a radius around a point location (e.g., a store) or a region by specifying a predefined set of boundaries (e.g, neighborhood boundaries). When a location-aware device (e.g., a smart phone) of a location-based service (LBS) enters or exits a geo-fence, the device can receive a notification from the LBS. This notification can contain information related to the location of the device. The notification can be sent to the device as a text message, email or even a telephone call.

### SUMMARY

The disclosed implementations provide a system and method of generating or updating a geo-fence surrounding a geographic region based on movement patterns of a device operating within the geographic region. In some implementations, an anchor location is selected by a user or application. A default geo-fence can be generated that surrounds a geographic region containing the anchor point. Data points are collected by the device based on sensor measurements and timestamps over a selectable period of time. The system analyzes the data points to generate a geo-fence surrounding a geographic region containing the anchor location (if no default geo-fence is defined) or updates a geo-fence to encompass more or less of a geographic region containing the anchor location.

In general, one innovative aspect of the subject matter described in this specification can be embodied in methods that include the actions of determining an anchor location; receiving input indicating a movement pattern of a mobile device in relation to the anchor location; and generating or updating a geo-fence surrounding a region containing the anchor location based at least on the movement pattern. Other embodiments of this aspect include corresponding systems, apparatus, and computer programs, configured to perform the actions of the methods, encoded on computer storage devices.

These and other embodiments can each optionally include one or more of the following features. The input is sensor data from one or more sensors onboard the mobile device. The sensor data includes at least one of accelerometer data and location coordinates. The location coordinates include longitude and latitude. Generating a default geo-fence surrounding the region containing the anchor location. The movement pattern is based on a plurality of data points collected over a period of time, and the data points include location coordinates and dwell time. The geo-fence surrounds a geographic region associated with a subset of data points in the plurality of data points that satisfy a threshold associated with the dwell time. The data points are collected within a maximum radius around the anchor location. Associating the geo-fence with a label. The anchor location is determined from a contact list or address book stored onboard the device or accessible by the device through a network service.

Particular implementations of geo-fence generation and updating based on movement patterns can provide several advantages, including allowing users to more accurately generate geo-fences based on their actual movement patterns over a period of time, and to update automatically those geo-fences when the user's movement patterns change.

### DESCRIPTION OF DRAWINGS

FIGS. 1A-1F illustrate an exemplary process of generating or updating a geo-fence surrounding a region containing an anchor location based on sensor input from a mobile device.

FIG. 2 illustrates an exemplary table in a database that stores data points when the mobile device is in tracking mode.

FIG. 3 is a block diagram of an exemplary system that provides pattern-based geo-fence generation or updating.

FIG. 4 is a flow diagram of an exemplary process for pattern-based geo-fence generation or updating.

FIG. 5 is a block diagram of an exemplary operating environment capable of providing pattern-based geo-fence generation or updating.

FIG. 6 is a block diagram of an exemplary architecture of a mobile device capable of providing pattern-based geo-fence generation or updating.

The same reference symbol used in various drawings indicates like elements.

### DETAILED DESCRIPTION

The disclosure that follows describes a network-enabled system application that provides reminders based on region. The network-enabled system application can be delivered by one or more server computers to one or more remotely located mobile devices using the World Wide Web (“the Web”). Although the disclosed implementations are network-enabled, the disclosed implementations can also be included in a “stand-alone” client application running on a device or in a network-enabled system that includes processes that execute on the network and the device.

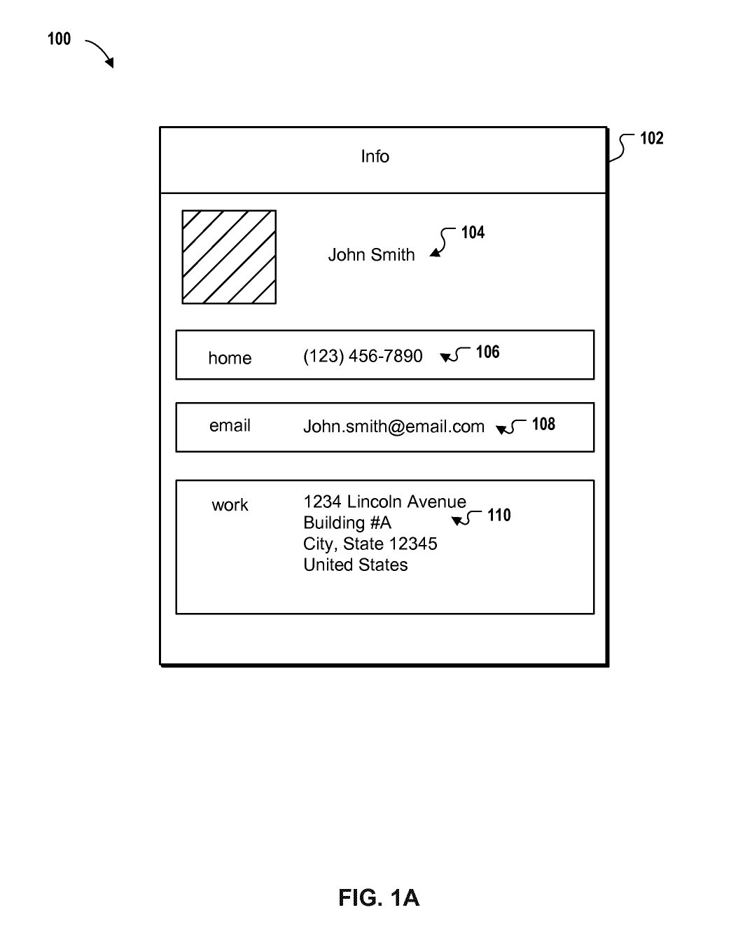

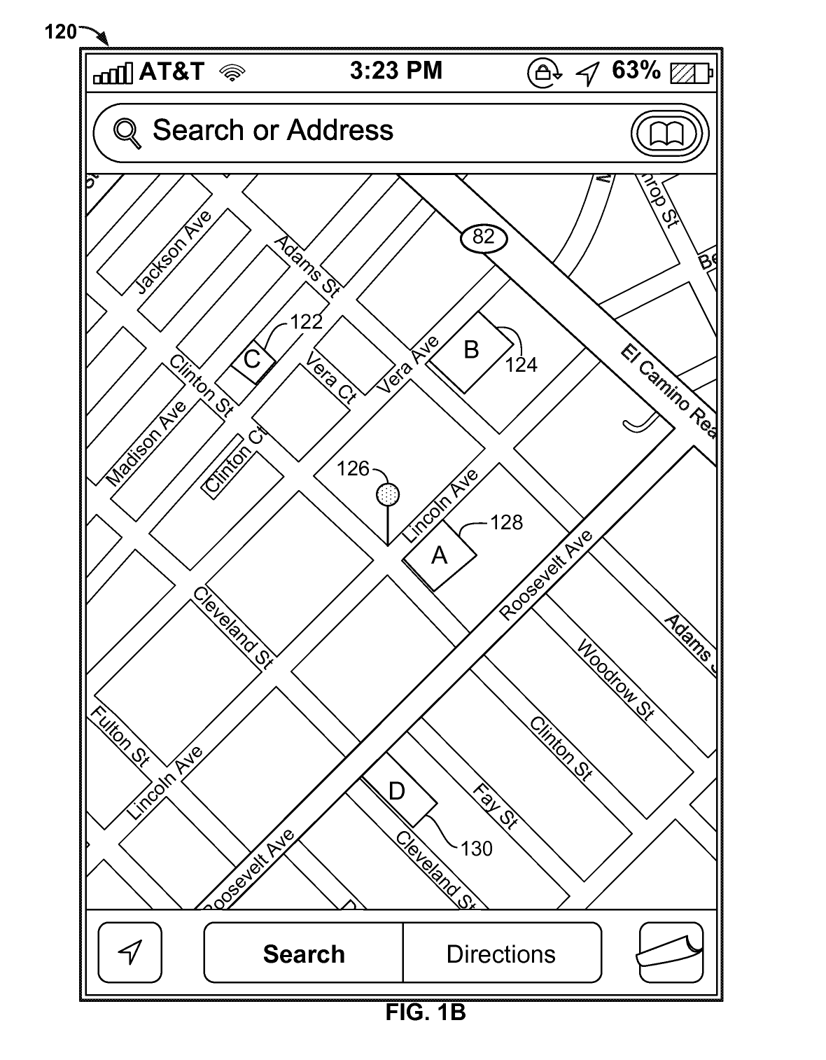

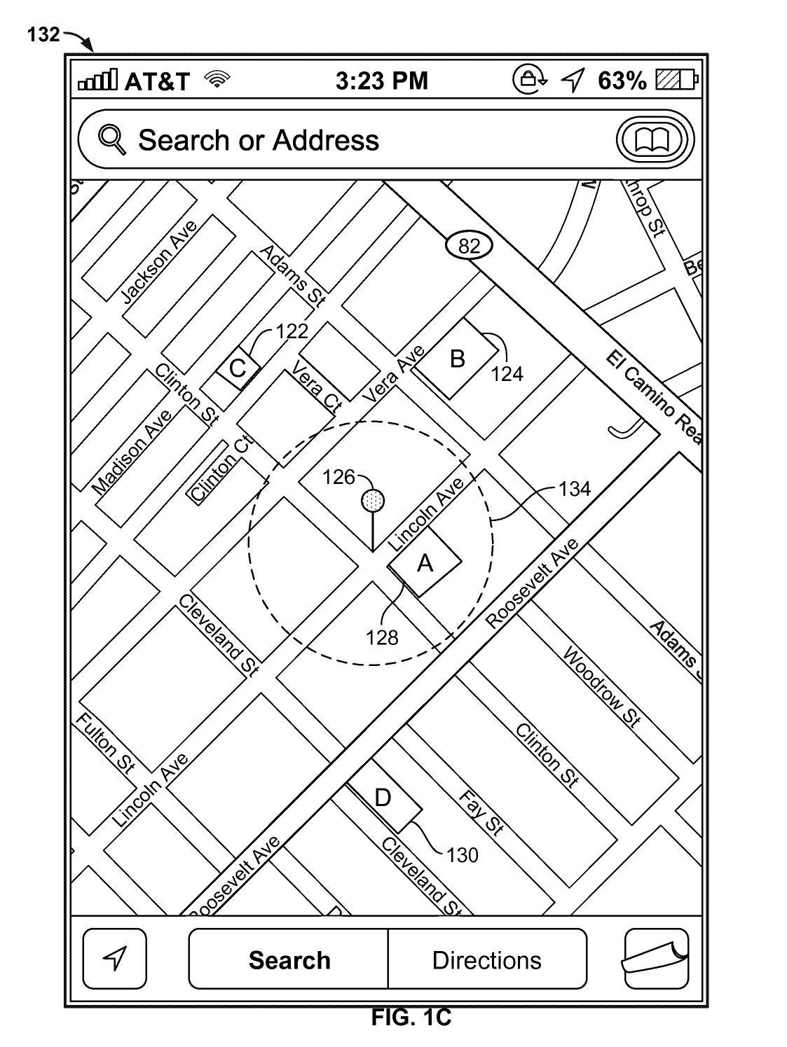

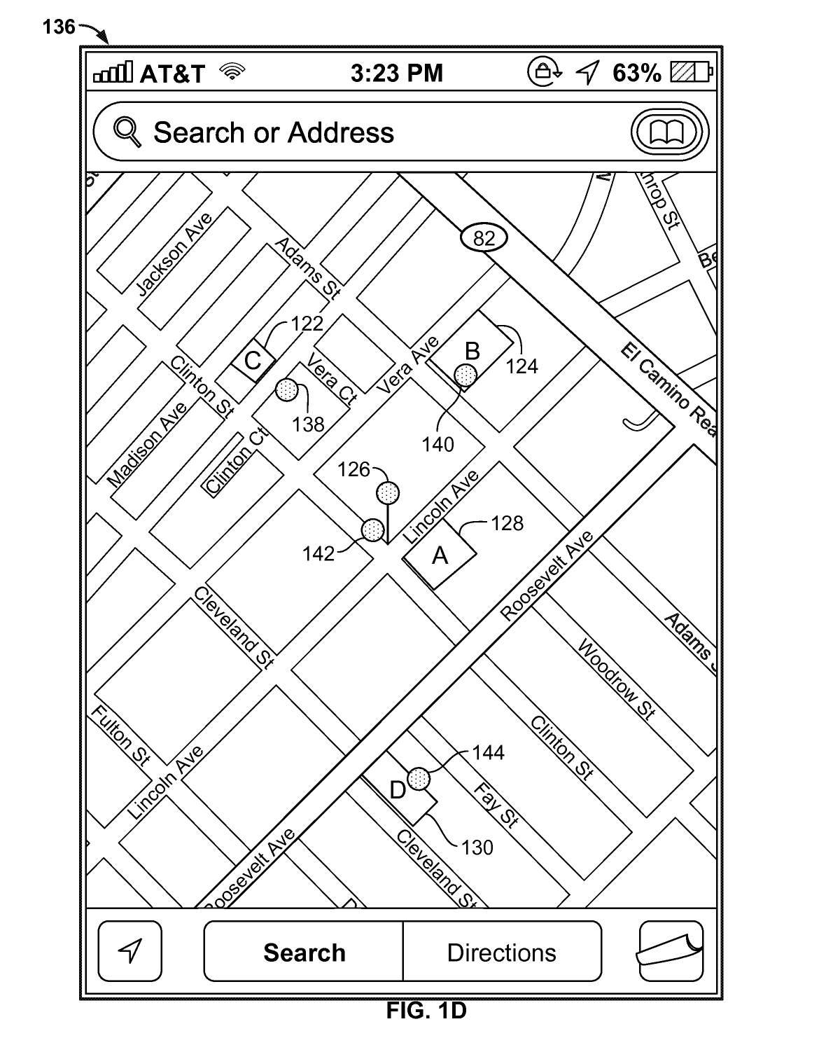

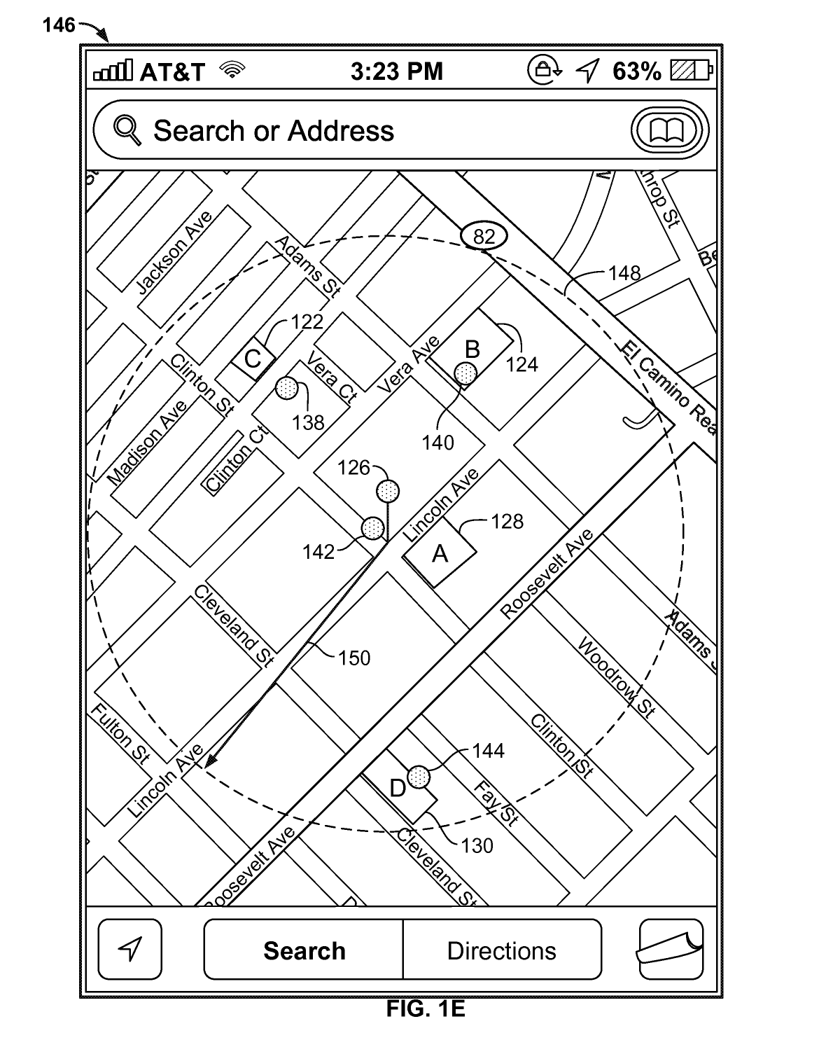

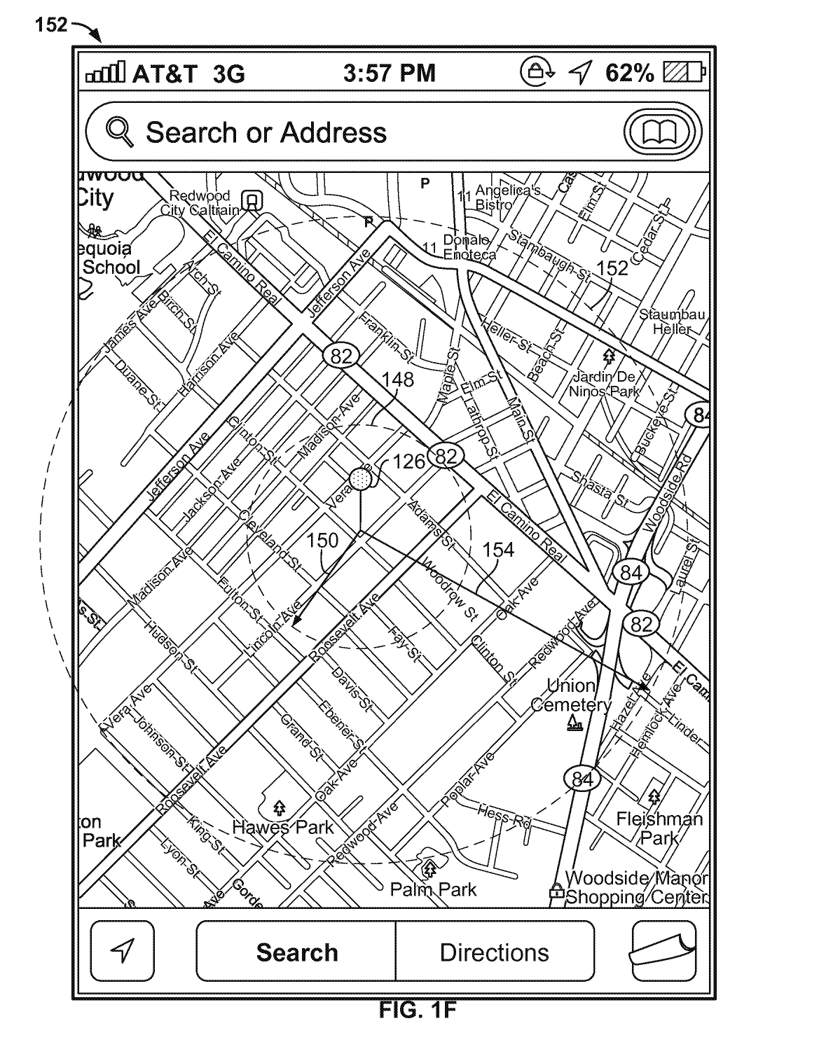

FIGS. 1A-1F illustrate an exemplary process of generating or updating a geo-fence surrounding a geographic region containing an anchor location based on sensor input from a mobile device. An “anchor” location can be a point location selected by a user or automatically by an application. For example, a user or application can select the anchor location from a database (e.g., a contact or address book) on the mobile device or network database operated by an LBS or other entity. The mobile device and/or LBS (hereinafter “the system”) can track the mobile device's movement patterns associated with the anchor location. Based on the mobile device's movements, which can include measurements of acceleration, position, and the amount of time spent at any location (“dwell time”), the system can automatically generate or update a geo-fence that surrounds a geographic region containing the anchor location and that also encloses other destinations traversed by the user in the vicinity of the anchor location.

For example, an anchor location can be an address of a building where the user's office is located. This building can be one address within a larger campus of buildings having different addresses. In one example use scenario, if the user frequently travels to different buildings on the campus, a default “work location” geo-fence that surrounds the building where the user's office is located (a point location) can be updated (e.g., expanded) to include the other buildings on the campus that are frequented by the user during work hours. Thus, a more accurate “work location” geo-fence can be created that better captures the user's whereabouts during work hours. Once the updated geo-fence is established by the system, the system can perform actions based on whether the mobile device is within the geographic region surrounded by the geo-fence. For example, the system can set a reminder on the mobile device when the mobile device enters or exits the region (e.g., through a calendar application) or send a communication to the mobile device, directly or indirectly (e.g., through a social network or blog account). The communication can be a text message, email, telephone call, ringtone, vibration or any other audio, visual or tactile feedback technology.

FIG. 1A illustrates an exemplary application view 100 that a user interfaces with to select an anchor location. The application view 100 can be displayed on a mobile device 102. In the example shown, the application view 100 is a contact from a contact database or address book stored on the device. The contact displays contact information about a contact on the mobile device, including the contact's name 104, phone number 106, email 108, or a work address 110. In this example, the application view 100 shows the user's contact information. In some implementations, the user can select the work address 110 as an anchor location to establish a “work location” geo-fence. The system receives the user's input and establishes the work address 110 as the anchor location. The system can use the work address 110 as a label to identify the anchor location. The system can then enter into a tracking mode, which will start the process of updating regions based on tracking information. Tracking mode can be entered by the user manually or automatically by an application or operating system. In some implementations, the system notifies the user that the mobile device has entered or exited the tracking mode. In some implementations, the system requests the user's approval to enter or exit the tracking mode.

FIG. 1B illustrates an exemplary map view 120 of an anchor location 126 that does not yet have a generated geo-fenced region. After the anchor location 126 is established as described in reference to FIG. 1A, the system starts to track movements of the mobile device. The mobile device's movements can include measurements of the mobile device's acceleration, velocity, heading or dwell time at a given longitude, latitude and altitude. The system can then associate the tracking information to the anchor location, as described in reference to FIGS. 1D-1F.

In some implementations, the anchor location 126 can be located near addresses that the mobile device frequently visits. For example, the anchor location 126 can be on a work campus that includes four work buildings 128 (“A”), 124 (“B”), 122 (“C”), and 130 (“D”). Until the system tracks enough information to reliably determine a geo-fence, the system can refrain from generating a geo-fence surrounding a geographic region containing the anchor location. In some implementations, the system generates a geo-fence after tracking a day's worth of data. In some implementations, the system generates a geo-fence after tracking a week's worth of data. Other time periods are also possible.

FIG. 1C illustrates an exemplary map view 132 of a default geo-fenced region 134 surrounding a geographic region containing the anchor location 126. In some implementations, instead of having an initially undefined region as described in reference to FIG. 1B, the system generates a default circular geo-fenced region 134 surrounding the anchor location 126 without entering the tracking mode. After entering into the tracking mode, the default geo-fenced region 134 can be updated (e.g., expanded or contracted) based on movement patterns obtained from sensor data generated onboard the mobile device.

FIG. 1D illustrates an exemplary map view 136 of a movement pattern of the mobile device. The system periodically tracks information regarding the mobile device to produce a movement pattern. In the example shown, data representing the movement pattern can be represented by data points 138, 140, 142, 144. Each data point can include a longitude, latitude, altitude, acceleration, gyroscope measurement, or dwell time. In some implementations, acceleration is used to measure the dwell time by observing a zero or near zero horizontal acceleration vector over a period of time. Dwell time can also be determined based on position readings from a positioning system (e.g., GPS, WiFi, Cell based), by measuring the elapsed time that position readings remain tightly clustered around a point location over a period of time.

FIG. 1E illustrates an exemplary map view 146 of the system generating a geo-fence surrounding a geographic region containing the anchor location 126. In some implementations, the movement pattern can contain hundreds of data points. For simplicity, the movement pattern will be described with respect to the four data points 138, 140, 142, 144 as shown in FIG. 1E.

The system can first aggregate the amount of time spent at data points that have the same location. In some implementations, the system aggregates data points having locations within a small delta radius of each other. By aggregating data points, the system can accurately consider the amount of time the mobile device has spent at a location, especially if the mobile device were to leave and return to the location. The system then selects a set of locations that satisfy a threshold of the minimum amount of dwell time spent at any location (e.g., 1 hour). In the example shown, the system can select the location in the set of locations that is farthest from the anchor location 126 and define a circular geo-fenced region 148 having a radius 150 that is based on the distance of the selected location to the anchor location 126. Although in this example a circular region is shown, the geo-fenced region 148 does not need to be circular. In some implementations, the shape of the region can be polygonal. Data points that only occur a few times over a given period of time can be excluded from the geo-fence update calculation. For example, in the work example described above, the user may visit a building on campus for a long dwell time (e.g., several hours) but only once a month or year due a one time event (e.g., a meeting). Such a data point can be excluded from geo-fence calculations as being an outlier data point, thus avoiding updating the geo-fence radius to encompass the building.

FIG. 1F illustrates an exemplary map view 152 of a maximum radius 154 defining a geo-fence around the anchor location 126. In this example, the system can track motion within a maximum radius 154 around the anchor location 126 and ignore any movement of the mobile device outside the maximum radius 154. In some implementations, the maximum radius 154 can be determined by an application or set by the user of the mobile device.

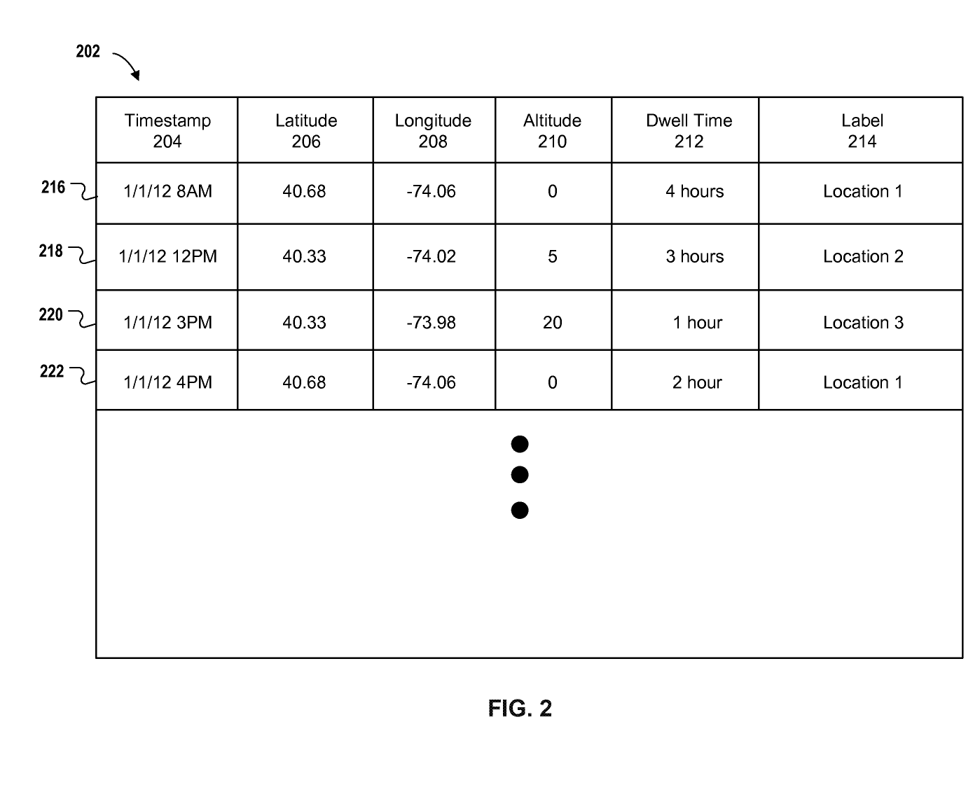

FIG. 2 illustrates an exemplary table 202 in a database that stores data points when the mobile device is in tracking mode. In some implementations, the system can trigger a data point store when the state of the mobile device changes. For example, if the dwell time at a given location exceeds a threshold value (e.g., 10 minutes), then data points can be stored at predetermined time intervals (e.g., store data point every 5 minutes). In some implementations, the system can store a data point over an interval of time after entering tracking mode. For example, data points can be stored for a period of time related to the type of geo-fence. For example, if it is a work related geo-fence, the tracking and storing of data points can be performed between 9:00 AM and 5:00 PM or other suitable period of time.

In some implementations, the data points, which can be stored in a database table, can include a timestamp 204, a latitude 206, a longitude 208, an altitude 210, the dwell time 212, and a label representing the location 214. The timestamp 204 can be a date and time. The latitude 206, longitude 208, and altitude 210 can be stored as decimal values in the table. The dwell time 212 at a location can be calculated by differences in accelerations or position measurements over a period of time. For example, a substantially non-zero acceleration over a period of time can imply the mobile device is non-stationary. In some implementations, if the system measures a series of data points having non-zero accelerations followed by a series of data points having zero accelerations and further followed by a series of data points having non-zero accelerations while all measured at the same location, the system can deduce the dwell time of the mobile device is equivalent to the timestamp difference between the two series of non-zero accelerations.

Referring to the table of FIG. 2, rows 216-222 illustrate sample data points measured at different times on Jan. 1, 2012 between the hours of 8:00 AM and 4:00 PM. The latitude 206 and longitude 208 parameters indicate the mobile device has been at the same location (location 1) on two separate occasions while the mobile device is in tracking mode. As a result, the system can aggregate the dwell times for these two separate occasions when generating a geo-fence, as discussed in reference to FIG. 1. In the example shown, the device was at location 1 from 8:00 AM to 12:00 PM or 4 hours, and at location 1 between the hours of 4:00 PM until 6:00 or 2 hours. Thus, the total dwell time at location 1 on Jan. 1, 2012 is 6 hours, indicating that the individual spent a significant part of their workday at location 1. If this pattern of long dwell times at location 1 occurs during the work week over a period of time, then location 1 would be considered a destination that should be included within a work related, expanded geo-fence, such as described in reference to FIG. 1E. So the radius of a circular geo-fence can be sized to encompass location 1.

In some implementations, data points in the database can include levels of accuracy. A level of accuracy can be an estimate of how accurate a location is. For example, a location inside of a building can have a lower accuracy than a location outside in an open parking lot. The level of accuracy can be represented by a unit of linear measure (e.g., meters). For example, a data point can be accurate within 100 meters. In some implementations, the system can obtain a data point's level of accuracy from the sensor data (e.g., a GPS positioning system). The system can choose to expand a geo-fence around a data point having a high level of accuracy while not expanding the geo-fence around a data point having a low level of accuracy.

In some implementations, data points in the database can include measured radii. A measured radius can indicate how much the movement a user device experiences over a duration of time. For example, referring to row 216, if a user sits at a desk and moves to another office, the measured radius can be the distance from the desk to the other office. In some implementations, the radius defines an outer boundary of movement around a location. The radius can be represented in meters. The system can obtain a data point's measured radius from the sensor data (e.g., a GPS positioning system). The system can choose to expand a geo-fence around an area measured by a measured radius revolving around a data point location having a high dwell time. In this situation, the high dwell time can indicate a user commonly frequents the area around the data point location. On the other hand, the system can choose to expand the geo-fence around a data point location having a low dwell time but not expand the geo-fence around an area measured by a measured radius revolving around the data point location. In this situation, the low dwell time can indicate a user does not frequent the area enough to warrant the system to expand the geo-fence around not only the data point location, but also the area. In some implementations, data points having levels of accuracy and measured radii can help the system expand geo-fences for regions of arbitrary shape (e.g., polygonal region).

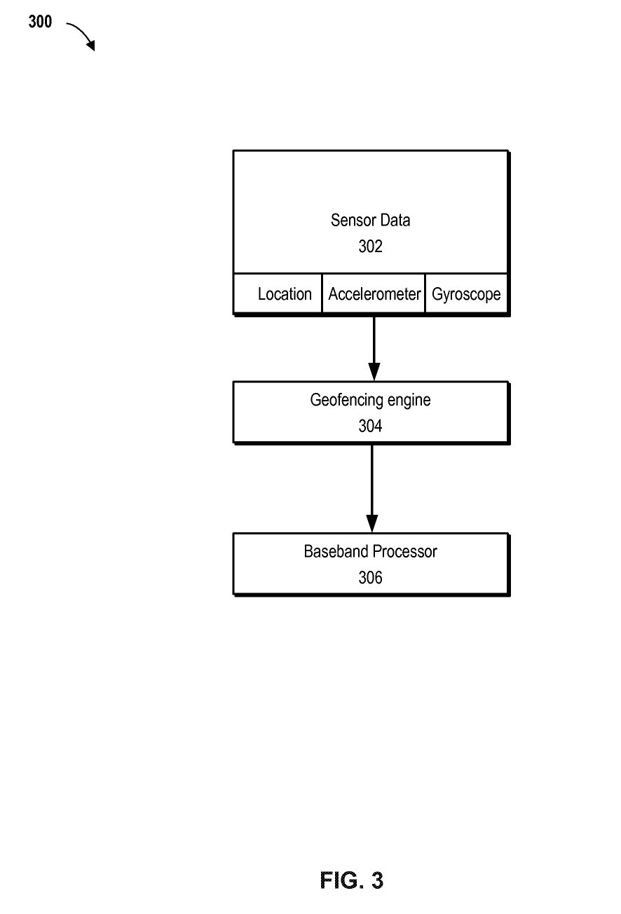

FIG. 3 is a block diagram of an exemplary system 300 that provides pattern-based geo-fence generation or updating. The system 300 obtains sensor data 302 of the mobile device. The sensor data 302 can include data (position, velocity) from a positioning system (e.g., GPS, WiFi, cell-based), an accelerometer, a gyroscope, or other sensors onboard the mobile device. This sensor data 302 can be passed to a geofencing engine 304. In some implementations, the geofencing engine can implement the features and processes described in FIGS. 1A-1F. The geofencing engine 304 can generate a geo-fence defining a region, which is processed by a baseband processor 306. The baseband processor 306 can detect when the mobile device enters or exits the geo-fenced region. On either event, the baseband processor 306 can trigger the mobile device to perform an action. In some implementations, this action can be a reminder or notification to the user of the mobile device related to the geo-fenced region. For example, the system 300 can remind the user of the mobile device to call home when the user exits a geo-fenced region surrounding the user's work.

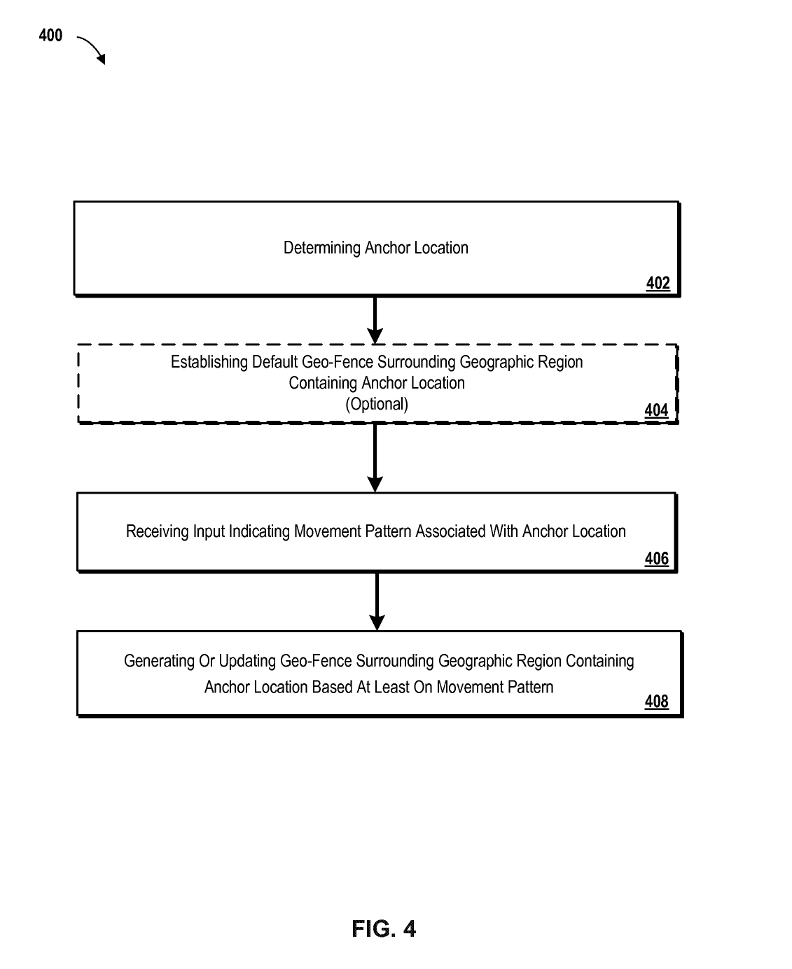

FIG. 4 illustrates a flow diagram of an exemplary process 400 for pattern-based geo-fence generation or updating. In some implementations, the process 400 can begin by determining an anchor location 402. The process 400 can optionally continue with setting up a default geo-fence around the anchor location 404. For example, a user can set-up a default radius for a circular geo-fence around their work address or other anchor desired location (e.g., the user's home). In some implementations, the process 400 does not include a default geo-fence and will delay generating a geo-fence surrounding the anchor location until the last step in process 400, described below.

The process 400 can continue by receiving input indicating a movement pattern associated with the anchor location 406. In some implementations, the movement pattern can be determined by analyzing a database of data points (e.g., dwell times) stored by the device over a period of time. The process 400 can then continue by generating a geo-fence or updating a default geo-fence based at least on the movement pattern 408.

### Exemplary Operating Environment

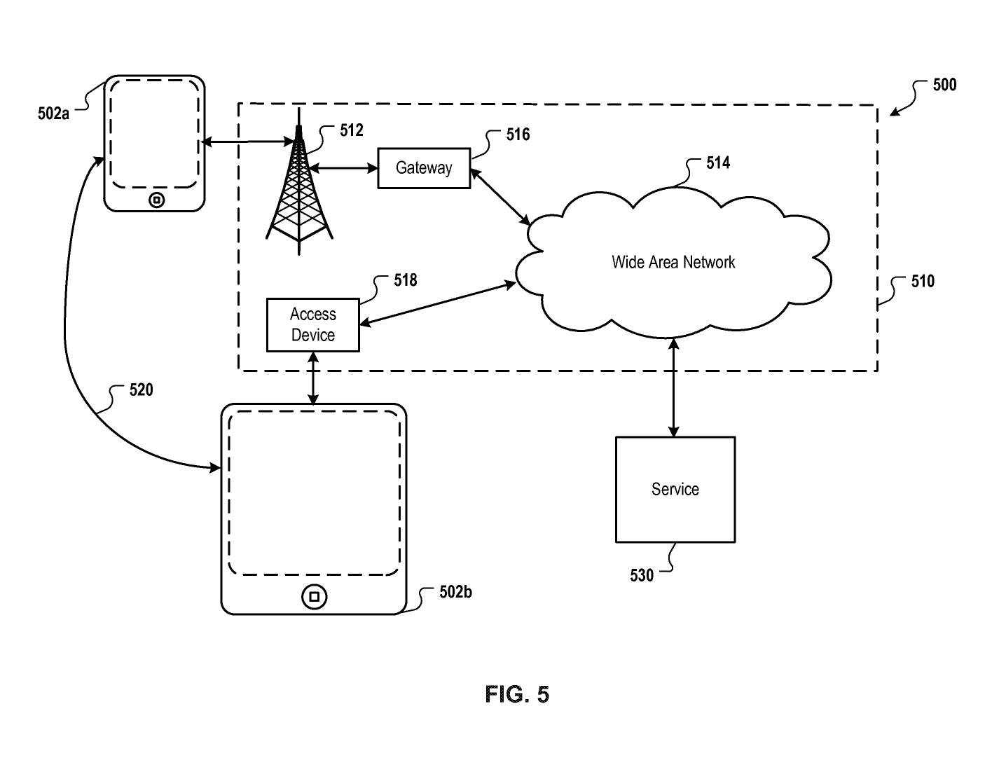

FIG. 5 is a block diagram of an exemplary operating environment for a device capable of providing pattern-based geo-fence generation or updating. In some implementations, devices 502a and 502b can communicate over one or more wired or wireless networks 510. For example, wireless network 512 (e.g., a cellular network) can communicate with a wide area network (WAN) 514 (e.g., the Internet) by use of gateway 516. Likewise, access device 518 (e.g., IEEE 802.11g wireless access device) can provide communication access to WAN 514. Devices 502a, 502b can be any device capable of displaying GUIs of the disclosed content authoring application, including but not limited to portable computers, smart phones and electronic tablets. In some implementations, the devices 502a, 502b do not have to be portable but can be a desktop computer, television system, kiosk system or the like.

In some implementations, both voice and data communications can be established over wireless network 512 and access device 518. For example, device 502a can place and receive phone calls (e.g., using voice over Internet Protocol (VoIP) protocols), send and receive e-mail messages (e.g., using SMPTP or Post Office Protocol 3 (POP3)), and retrieve electronic documents and/or streams, such as web pages, photographs, and videos, over wireless network 512, gateway 516, and WAN 514 (e.g., using Transmission Control Protocol/Internet Protocol (TCP/IP) or User Datagram Protocol (UDP)). Likewise, in some implementations, device 502b can place and receive phone calls, send and receive e-mail messages, and retrieve electronic documents over access device 518 and WAN 514. In some implementations, device 502a or 502b can be physically connected to access device 518 using one or more cables and access device 518 can be a personal computer. In this configuration, device 502a or 502b can be referred to as a “tethered” device.

Devices 502a and 502b can also establish communications by other means. For example, wireless device 502a can communicate with other wireless devices (e.g., other devices 502a or 502b, cell phones) over the wireless network 512. Likewise, devices 502a and 502b can establish peer-to-peer communications 520 (e.g., a personal area network) by use of one or more communication subsystems, such as the Bluetooth™ communication devices. Other communication protocols and topologies can also be implemented.

Devices 502a or 502b can communicate with service 530 over the one or more wired and/or wireless networks 510. For example, service 530 can be an online service that stores geo-fence parameters and data points and/or provides notifications to users or other individuals or entities related to geo-fence trigger events, including the features described in reference to FIGS. 1-4.

Device 502a or 502b can also access other data and content over one or more wired and/or wireless networks 510. For example, content publishers, such as news sites, Really Simple Syndication (RSS) feeds, Web sites and developer networks can be accessed by device 502a or 502b. Such access can be provided by invocation of a web browsing function or application (e.g., a browser) running on the device 502a or 502b.

Devices 502a and 502b can exchange files over one or more wireless or wired networks 510 either directly or through service 530.

### Exemplary Device Architecture

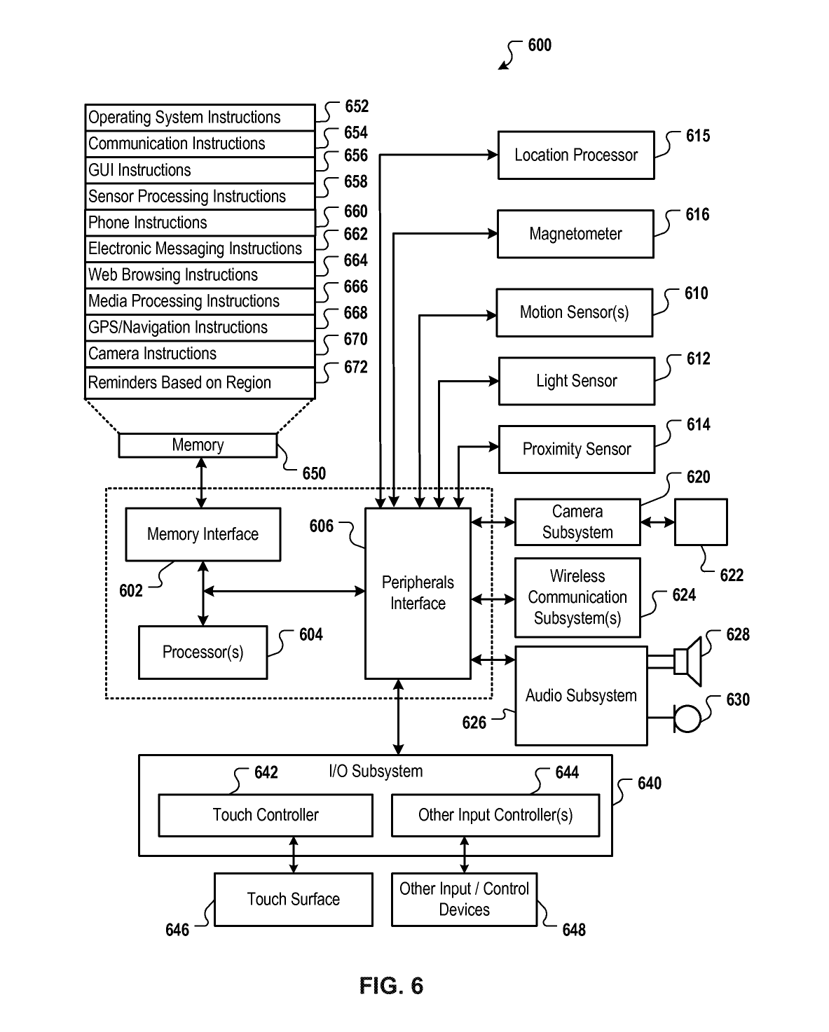

FIG. 6 illustrates a block diagram of an exemplary architecture of a mobile device capable of providing pattern-based geo-fence generation or updating. Architecture 600 can be implemented in any device for generating the features described in reference to FIGS. 1-9, including but not limited to portable or desktop computers, smart phones and electronic tablets, television systems, game consoles, kiosks and the like. Architecture 600 can include memory interface 602, data processor(s), image processor(s) or central processing unit(s) 604, and peripherals interface 606. Memory interface 602, processor(s) 604 or peripherals interface 606 can be separate components or can be integrated in one or more integrated circuits. The various components can be coupled by one or more communication buses or signal lines.

Sensors, devices, and subsystems can be coupled to peripherals interface 606 to facilitate multiple functionalities. For example, motion sensor 610, light sensor 612, and proximity sensor 614 can be coupled to peripherals interface 606 to facilitate orientation, lighting, and proximity functions of the device. For example, in some implementations, light sensor 612 can be utilized to facilitate adjusting the brightness of touch surface 646. In some implementations, motion sensor 610 (e.g., an accelerometer, gyros) can be utilized to detect movement and orientation of the device. Accordingly, display objects or media can be presented according to a detected orientation (e.g., portrait or landscape).

Other sensors can also be connected to peripherals interface 606, such as a temperature sensor, a biometric sensor, or other sensing device, to facilitate related functionalities.

Location processor 615 (e.g., GPS receiver) can be connected to peripherals interface 606 to provide geo-positioning. Electronic magnetometer 616 (e.g., an integrated circuit chip) can also be connected to peripherals interface 606 to provide data that can be used to determine the direction of magnetic North. Thus, electronic magnetometer 616 can be used as an electronic compass.

Camera subsystem 620 and an optical sensor 622, e.g., a charged coupled device (CCD) or a complementary metal-oxide semiconductor (CMOS) optical sensor, can be utilized to facilitate camera functions, such as recording photographs and video clips.

Communication functions can be facilitated through one or more communication subsystems 624. Communication subsystem(s) 624 can include one or more wireless communication subsystems. Wireless communication subsystems 624 can include radio frequency receivers and transmitters and/or optical (e.g., infrared) receivers and transmitters. Wired communication system can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving or transmitting data. The specific design and implementation of the communication subsystem 624 can depend on the communication network(s) or medium(s) over which the device is intended to operate. For example, a device may include wireless communication subsystems designed to operate over a global system for mobile communications (GSM) network, a GPRS network, an enhanced data GSM environment (EDGE) network, 802.x communication networks (e.g., WiFi, WiMax, or 3G networks), code division multiple access (CDMA) networks, and a Bluetooth™ network. Communication subsystems 624 may include hosting protocols such that the device may be configured as a base station for other wireless devices. As another example, the communication subsystems can allow the device to synchronize with a host device using one or more protocols, such as, for example, the TCP/IP protocol, HTTP protocol, UDP protocol, and any other known protocol.

Audio subsystem 626 can be coupled to a speaker 628 and one or more microphones 630 to facilitate voice-enabled functions, such as voice recognition, voice replication, digital recording, and telephony functions.

I/O subsystem 640 can include touch controller 642 and/or other input controller(s) 644. Touch controller 642 can be coupled to a touch surface 646. Touch surface 646 and touch controller 642 can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch surface 646. In one implementation, touch surface 646 can display virtual or soft buttons and a virtual keyboard, which can be used as an input/output device by the user.

Other input controller(s) 644 can be coupled to other input/control devices 648, such as one or more buttons, rocker switches, thumb-wheel, infrared port, USB port, and/or a pointer device such as a stylus. The one or more buttons (not shown) can include an up/down button for volume control of speaker 628 and/or microphone 630.

In some implementations, device 600 can present recorded audio and/or video files, such as MP3, AAC, and MPEG files. In some implementations, device 600 can include the functionality of an MP3 player and may include a pin connector for tethering to other devices. Other input/output and control devices can be used.

Memory interface 602 can be coupled to memory 650. Memory 650 can include high-speed random access memory or non-volatile memory, such as one or more magnetic disk storage devices, one or more optical storage devices, or flash memory (e.g., NAND, NOR). Memory 650 can store operating system 652, such as Darwin, RTXC, LINUX, UNIX, OS X, WINDOWS, or an embedded operating system such as VxWorks. Operating system 652 may include instructions for handling basic system services and for performing hardware dependent tasks. In some implementations, operating system 652 can include a kernel (e.g., UNIX kernel).

Memory 650 may also store communication instructions 654 to facilitate communicating with one or more additional devices, one or more computers or servers. Communication instructions 654 can also be used to select an operational mode or communication medium for use by the device, based on a geographic location (obtained by the GPS/Navigation instructions 668) of the device. Memory 650 may include graphical user interface instructions 656 to facilitate graphic user interface processing, such as generating the GUIs shown in FIGS. 1-8; sensor processing instructions 658 to facilitate sensor-related processing and functions; phone instructions 660 to facilitate phone-related processes and functions; electronic messaging instructions 662 to facilitate electronic-messaging related processes and functions; web browsing instructions 664 to facilitate web browsing-related processes and functions and display GUIs described in reference to FIGS. 1-8; media processing instructions 666 to facilitate media processing-related processes and functions; GPS/Navigation instructions 668 to facilitate GPS and navigation-related processes; camera instructions 670 to facilitate camera-related processes and functions; and instructions 672 for a reminders based on region application that is capable of displaying GUIs, as described in reference to FIGS. 1-8. The memory 650 may also store other software instructions for facilitating other processes, features and applications, such as applications related to navigation, social networking, location-based services or map displays.

Each of the above identified instructions and applications can correspond to a set of instructions for performing one or more functions described above. These instructions need not be implemented as separate software programs, procedures, or modules. Memory 650 can include additional instructions or fewer instructions. Furthermore, various functions of the mobile device may be implemented in hardware and/or in software, including in one or more signal processing and/or application specific integrated circuits.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer can communicate with mass storage devices for storing data files. These mass storage devices can include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with an author, the features can be implemented on a computer having a display device such as a CRT (cathode ray tube) or LCD (liquid crystal display) monitor for displaying information to the author and a keyboard and a pointing device such as a mouse or a trackball by which the author can provide input to the computer.

The features can be implemented in a computer system that includes a back-end component, such as a data server or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a LAN, a WAN and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an Application Programming Interface (API). An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, etc.

A number of implementations have been described. Nevertheless, it will be understood that various modifications may be made. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
determining an anchor location;
monitoring a movement of a mobile device in relation to the anchor location; and
generating or updating a geo-fence surrounding a region containing the anchor location based at least on the monitored movement of the mobile device.

2. The method of claim 1, wherein monitoring the movement of the mobile device comprises receiving input indicating the movement of the mobile device, wherein the input is sensor data from one or more sensors onboard the mobile device.

3. The method of claim 2, where the sensor data includes at least one of accelerometer data and location coordinates.

4. The method of claim 3, where the location coordinates include longitude and latitude.

5. The method of claim 1, generating a default geo-fence surrounding the region containing the anchor location.

6. The method of claim 1, wherein monitoring the movement of the mobile device comprises:
collecting a plurality of data points over a period of time, wherein the data points include location coordinates and dwell time; and
generating a movement pattern based on the plurality of data points collected over the period of time.

7. The method of claim 6, where the geo-fence surrounds a geographic region associated with a subset of data points in the plurality of data points that satisfy a threshold associated with the dwell time.

8. The method of claim 7, where the data points are collected within a maximum radius around the anchor location.

9. The method of claim 1, further comprising associating the geo-fence with a label.

10. The method of claim 8, where the anchor location is determined from a contact list or address book stored onboard the device or accessible by the device through a network service.

11. A system comprising:
one or more processors;
memory coupled to the one or more processors and configured to store instructions, which, when executed by the one or more processors, causes the processors to perform operations comprising:
determining an anchor location;
monitoring a movement of a mobile device through a plurality of locations in relation to the anchor location, wherein the mobile device was physically present at each of the plurality of locations; and
generating or updating a geo-fence surrounding a region containing the anchor location based at least on the monitored movement of the mobile device and the plurality of locations at the mobile device was physically present.

12. The system of claim 11, wherein monitoring the movement of the mobile device comprises receiving input indicating the movement of the mobile device through the plurality of locations, wherein the input is sensor data from one or more sensors onboard the mobile device.

13. The system of claim 12, where the sensor data includes at least one of accelerometer data and location coordinates.

14. The system of claim 13, where the location coordinates include longitude and latitude.

15. The system of claim 11, generating a default geo-fence surrounding the region containing the anchor location.

16. The system of claim 11, wherein monitoring the movement of the mobile device through the plurality of locations comprises:
collecting a plurality of data points over a period of time, wherein the data points include location coordinates and dwell time; and
generating a movement pattern based on the plurality of data points collected over the period of time.

17. The system of claim 16, where the geo-fence surrounds a geographic region associated with a subset of data points in the plurality of data points that satisfy a threshold associated with the dwell time.

18. The system of claim 17, where the data points are collected within a maximum radius around the anchor location.

19. The system of claim 11, further comprising associating the geo-fence with a label.

20. The system of claim 18, where the anchor location is determined from a contact list or address book stored onboard the device or accessible by the device through a network service.

21. A non-transitory computer-readable medium storing instructions executable by data processing apparatus to perform operations comprising:
determining an anchor location;
monitoring a movement of a mobile device in relation to the anchor location; and
generating or updating a geo-fence surrounding a region containing the anchor location based at least on the monitored movement of the mobile device.

22. The medium of claim 21, wherein the movement identifies a plurality of locations at which the mobile device is physically present.

23. The medium of claim 21, wherein generating the geo-fence surrounding the region comprises:
generating a default geo-fence surrounding the region containing the anchor location; and
updating the default geo-fence based at least on the monitored movement of the mobile device.

24. The medium of claim 21, wherein the anchor location is determined from a contact list or address book stored onboard the device or accessible by the device through a network service.

25. The medium of claim 21, wherein monitoring the movement of the mobile device comprises:
collecting a plurality of data points over a period of time, wherein the data points include location coordinates and dwell time; and
generating a movement pattern based on the plurality of data points collected over the period of time.
